(19) United States
(12) Patent Application Publication
(10) Pub. No.: US 2007/0082991 A1
(43) Pub. Date: Apr. 12, 2007

(54) Tread for pneumatic tires

(75) Inventors: Robert Chassagnon, Riom (FR); Didier Vasseur, Clermont-Ferrand (FR)

Correspondence Address: COHEN, PONTANI, LIEBERMAN & PAVANE, 551 FIFTH AVENUE, SUITE 1210, NEW YORK, NY, 10176, US

(73) Assignee: MICHELIN RECHERCHE ET TECHNIQUE, S.A., Granges-Paccot (CH)

(21) Appl. No.: 10/578,119

(22) PCT Filed: Oct. 29, 2004
(86) PCT No.: PCT/EP04/12237

§ 371 Date: May 1, 2006

(30) Foreign Application Priority Data
Oct. 30, 2003 (FR) 0312743

(51) Int. Cl. C09D 11/02

(52) U.S. Cl. 524/313

(57) ABSTRACT

The invention relates to a tread for pneumatic tyres with an improved capacity for adhesion to wet ground. Said tread consists of a rubber composition containing at least: (i) one dienic elastomer comprising more than 30 pce of rubber butyl, (ii) a reinforcing inorganic load such as silica, (iii) a coupling agent for the inorganic load, and, as a plastifying agent, (iv) a glycerol unsaturated fatty acid triester (C₁₂-C₂₂), especially a glycerol trioleate. The invention also relates to the use of one such tread for the production or the retreading of pneumatic tyres, and to the pneumatic tyres themselves.

The present invention relates to tire treads comprising rubber compositions reinforced by an inorganic filler.

It is known that a tire tread must meet a large number of technical demands, which are frequently contradictory, including low rolling resistance, high wear resistance and a high level of grip on dry and wet roads.

These compromises of properties, in particular from the point of view of rolling resistance and of wear resistance, have been improved in recent years on “Green Tires” of low energy consumption, which are intended in particular for passenger vehicles, owing to the use of new rubber compositions of low hysteresis having the characteristic of being reinforced majoritarily with specific inorganic fillers referred to as “reinforcing fillers”, in particular highly dispersible silicas referred to as “HDS” (Highly Dispersible Silica), which are capable of rivalling conventional tire-grade carbon blacks from the reinforcing ability point of view

Thus, nowadays, these reinforcing inorganic fillers are gradually replacing carbon blacks in the treads of tires, all the more so since they have another known virtue, that of increasing the grip of the tires on wet, snow-covered or icy roads.

Increasing the grip properties of tires nevertheless remains a constant preoccupation of tire designers.

Now, the Applicants have discovered during their research that the combined presence, in a rubber matrix reinforced with an inorganic filler, of a butyl rubber and, as plasticising agent, of a glycerol fatty acid triester made it possible to increase still further, and significantly, the grip of the treads, and therefore of the tires comprising them, on wet ground.

Thus, a first subject of the invention relates to a tire tread comprising at least a rubber composition, said composition comprising at least a diene elastomer, a reinforcing inorganic filler, a coupling agent and a plasticising agent, characterised in that the diene elastomer comprises more than 30 phr (parts by weight per hundred parts of elastomer) of butyl rubber and in that the plasticising agent comprises an unsaturated (C₁₂-C₂₂) fatty acid triester of glycerol.

The subject of the invention is also the use of such a tread for the manufacture of new tires or the retreading of worn tires.

The subject of the invention is also these tires themselves when they comprise a tread according to the invention.

The tires of the invention are particularly intended to be fitted on motor vehicles of passenger-vehicle type, SUVs (“Sport Utility Vehicles”), two-wheeled vehicles (in particular motorcycles), aircraft, and also industrial vehicles selected from among vans, “heavy vehicles”—that is to say subway trains, buses, road transport machinery (lorries, tractors, trailers), off-road vehicles such as agricultural machinery or construction machinery—and other transport or handling vehicles.

Another subject of the invention is a process for preparing a tire tread having improved grip on wet roads; this process comprises the following steps:
incorporating in a diene elastomer, in a mixer:
   a reinforcing inorganic filler;
   a coupling agent;
   a plasticising agent,
by thermomechanically kneading the entire mixture, in one or more stages, until a maximum temperature of between 130° C. and 200° C. is reached;
cooling the entire mixture to a temperature of less than 100° C.;
then incorporating:
   a cross-linking system;
kneading the entire mixture until a maximum temperature of less than 120° C. is reached;
extruding or calendering the rubber composition thus obtained, in the form of a tire tread;
   and it is characterised in that the diene elastomer comprises more than 30 phr of butyl rubber and in that the plasticising agent comprises an unsaturated (C₁₂-C₂₂) fatty acid triester of glycerol.

The invention and its advantages will be readily understood in the light of the description and the examples of embodiment which follow.

### I. DETAILED DESCRIPTION OF THE INVENTION

The tread according to the invention is formed, at least for its surface part which is intended to come into contact with the road, of a rubber composition based on at least: (i) a (at least one) diene elastomer; (ii) a (at least one) inorganic filler as reinforcing filler; (iii) a (at least one) coupling agent providing the bond between the reinforcing inorganic filler and the diene elastomer; (iv) a (at least one) plasticising agent; it is characterised in that the diene elastomer comprises more than 30 phr of butyl rubber and in that the plasticising agent comprises an unsaturated fatty acid triester of glycerol.

Of course, the expression composition “based on” is to be understood to mean a composition comprising the mix and/or the product of reaction in situ of the various constituents used, some of these base constituents (for example, the coupling agent) being liable to, or intended to, react together, at least in part, during the different phases of manufacturing of the treads, in particular during the vulcanisation (curing) thereof.

Unless expressly indicated otherwise, the percentages indicated in the present description are mass %.

I-1. Diene Elastomer

The tread according to the invention has the essential characteristic of comprising, as diene elastomer, more than 30 phr of butyl rubber. This butyl rubber may be used alone or in association with one or more other diene elastomer(s).

“Butyl rubber” is understood in known manner to mean a copolymer of isobutylene and isoprene (abbreviated to IIR), and also the halogenated, preferably chlorinated or brominated, versions of this type of copolymer. Preferably, the butyl rubber is a halogenated butyl rubber.

“Diene” elastomer or rubber is to be understood to mean, by definition, an elastomer resulting at least in part (i.e. a homopolymer or a copolymer) from diene monomers (monomers bearing two double carbon-carbon bonds, whether conjugated or not).

The diene elastomers, in known manner, may be classed in two categories: those referred to as “essentially unsaturated” and those referred to as “essentially saturated”.

Butyl rubbers, such as, for example, copolymers of dienes and of alpha-olefins of the EPDM type, fall within the category of essentially saturated diene elastomers, having a low or very low content of units of diene origin which is always less than 15% (mole %).

On the contrary, “essentially unsaturated” diene elastomer is understood to mean a diene elastomer resulting at least in part from conjugated diene monomers, having a content of members or units of diene origin (conjugated dienes) which is greater than 15% (mole %). Within the category of “essentially unsaturated” diene elastomers, “highly unsaturated” diene elastomer is understood to mean in particular a diene elastomer having a content of units of diene origin (conjugated dienes) which is greater than 50%.

The butyl rubber may constitute all (or 100 phr) or only a fraction of the diene elastomer taken as a whole, it being understood that this fraction of butyl rubber is always greater than 30 phr, preferably at least equal to 40 phr.

When the diene elastomer comprises a rubber other than butyl, in addition to the latter, it is then preferred to use at least one diene elastomer of the highly unsaturated type, in particular:
(a) any homopolymer obtained by polymerisation of a conjugated diene monomer having 4 to 12 carbon atoms;
(b) any copolymer obtained by copolymerisation of one or more conjugated dienes together or with one or more vinyl-aromatic compounds having 8 to 20 carbon atoms.

Suitable conjugated dienes are, in particular, 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds are, for example, stirene, ortho-, meta- and para-methylstirene, the commercial mixture “vinyltoluene”, para-tert. butylstirene, methoxystirenes, chlorostirenes, vinylmesitylene, divinylbenzene and vinylnaphthalene.

The copolymers may contain between 99% and 20% by weight of diene units and between 1% and 80% by weight of vinyl-aromatic units. The elastomers may have any microstructure, which is a function of the polymerisation conditions used, in particular of the presence or absence of a modifying and/or randomising agent and the quantities of modifying and/or randomising agent used. The elastomers may for example be block, random, sequential or microsequential elastomers, and may be prepared in dispersion or in solution; they may be coupled and/or starred or alternatively functionalised with a coupling and/or starring or functionalising agent.

Preferred are polybutadienes, and in particular those having a content of 1,2-units of between 4% and 80%, or those having a content of cis-1,4 of more than 80%, polyisoprenes, butadiene/stirene copolymers, and in particular those having a stirene content of between 5% and 50% by weight and, more particularly, between 20% and 40%, a content of 1,2-bonds of the butadiene fraction of between 4% and 65%, and a content of trans-1,4 bonds of between 20% and 80%, butadiene/isoprene copolymers and in particular those having an isoprene content of between 5% and 90% by weight and a glass transition temperature (“Tg”—measured in accordance with ASTM D3418-82) of from −40° C. to −80° C., isoprene/stirene copolymers and in particular those having a stirene content of between 5% and 50% by weight and a Tg of between −25° C. and −50° C. In the case of butadiene/stirene/isoprene copolymers, those which are suitable are in particular those having a stirene content of between 5% and 50% by weight and more particularly between 10% and 40%, an isoprene content of between 15% and 60% by weight, and more particularly between 20% and 50%, a butadiene content of between 5% and 50% by weight and more particularly between 20% and 40%, a content of 1,2-units of the butadiene fraction of between 4% and 85%, a content of trans-1,4 units of the butadiene fraction of between 6% and 80%, a content of 1,2- plus 3,4-units of the isoprene fraction of between 5% and 70%, and a content of trans-1,4 units of the isoprene fraction of between 10% and 50%, and more generally any butadiene/stirene/isoprene copolymer having a Tg of between −20° C. and −70° C.

In summary, when the butyl rubber is associated with another diene elastomer (or even several), the latter is preferably selected from the group of (highly unsaturated) diene elastomers consisting of polybutadienes (BR), synthetic polyisoprenes (IR), natural rubber (NR), butadiene copolymers, isoprene copolymers (other than IIR) and mixtures of these elastomers. Such copolymers are more preferably selected from the group consisting of butadiene/stirene copolymers (SBR), isoprene/butadiene copolymers (BIR), isoprene/stirene copolymers (SIR), isoprene/butadiene/stirene copolymers (SBIR) and mixtures of such copolymers.

One particularly preferred embodiment of the invention consists of using from 40 to 80 or even 90 phr of butyl rubber, the remainder (of 10 or 20 to 60 phr) being made up of one or more of the diene elastomers belonging to the group defined above.

The tread according to the invention is preferably intended for a passenger-car tire. In such a case, the diene elastomer preferably comprises, in addition to the butyl rubber, an SBR copolymer, in particular an SBR prepared in solution, whether used or not in a blend with a polybutadiene; more preferably, the SBR has a content of stirene of between 20% and 30% by weight, a content of vinyl bonds of the butadiene fraction of between 15% and 65%, a content of trans-1,4 bonds of between 15% and 75% and a Tg of between −20° C. and −55° C., and the polybutadiene has more than 90% cis-1,4 bonds.

However, the invention also applies to any other type of tire. In the case of a tire for an industrial vehicle such as a heavy vehicle for example, an isoprene elastomer, that is to say an isoprene homopolymer or copolymer, in other words a diene elastomer selected from among the group consisting of natural rubber (NR), synthetic polyisoprenes (IR), the different isoprene copolymers (other than isobutylene/isoprene) or a mixture of these elastomers, is preferably associated with the butyl rubber. Of the isoprene copolymers, mention will be made in particular of isoprene/stirene copolymers (SIR), isoprene/butadiene copolymers (BIR) or isoprene/butadiene/stirene copolymers (SBIR). This isoprene elastomer is preferably natural rubber or a synthetic cis-1,4 polyisoprene; of these synthetic polyisoprenes, preferably polyisoprenes having a content (mole %) of cis-1,4 bonds greater than 90%, more preferably still greater than 98%, are used. For such a tire, the diene elastomer may also be constituted, in its entirety or in part, of another highly unsaturated elastomer such as, for example, an SBR elastomer.

Any type of synthetic elastomer other than a diene elastomer, or even polymers other than elastomers, for example thermoplastic polymers, may be associated with the diene elastomers of the treads according to the invention.

I-2. Reinforcing Inorganic Filler

“Reinforcing inorganic filler” is to be understood here, in known manner, to mean any inorganic or mineral filler, whatever its colour and its origin (natural or synthetic), also referred to as “white” filler, “clear” filler or alternatively “non-black” filler, in contrast to carbon black, being capable, on its own, without any other means than an intermediate coupling agent, of reinforcing a rubber composition intended for the manufacture of a tire tread, in other words which is capable of replacing a conventional tire-grade carbon black (for treads) in its reinforcement function; such a filler is generally characterised, in known manner, by the presence of hydroxyl (—OH) groups at its surface.

Preferably, the reinforcing inorganic filler is a filler of the siliceous or aluminous type, or a mixture of these two types of fillers.

The silica (SiO₂) used may be any reinforcing silica known to the person skilled in the art, in particular any precipitated or filmed silica having a BET surface area and a specific CTAB surface area both of which are less than 450 m²/g, preferably from 30 to 400 m²/g. Highly dispersible precipitated silicas (referred to as “HDS”) are preferred, in particular when the invention is used for the manufacture of tires having a low rolling resistance; as examples of such silicas, mention may be made of the silicas Ultrasil 7000 from Degussa, the silicas Zeosil 1165 MP, 1135 MP and 1115 MP from Rhodia, the silica Hi-Sil EZ150G from PPG, and the silicas Zeopol 8715, 8745 or 8755 from Huber.

The reinforcing alumina (Al₂O₃) preferably used is a highly dispersible alumina having a BET surface area of from 30 to 400 m²/g, more preferably between 60 and 250 m²/g, and an average particle size at most equal to 500 nm, more preferably at most equal to 200 nm. Non-limitative examples of such reinforcing aluminas are in particular the aluminas “Baikalox A125” or “CR125” (from Baikowski), “APA-100RDX” (Condea), “Aluminoxid C” (Degussa) or “AKP-G015” (Sumitomo Chemicals).

By way of other examples of inorganic filler capable of being used in the rubber compositions of the treads of the invention, mention may also be made of the aluminium (oxide-) hydroxides, the titanium oxides or reinforcing silicon carbides (see for example application WO 02/053634).

When the treads of the invention are intended for tires of low rolling resistance, the reinforcing inorganic filler used, in particular if it is silica, preferably has a BET surface area of between 60 and 350 m²/g. One advantageous embodiment of the invention consists of using a reinforcing inorganic filler, in particular a silica, having a large BET specific surface area, within a range from 130 to 300 m²/g, owing to the recognised high reinforcing ability of such fillers. According to another preferred embodiment of the invention, a reinforcing inorganic filler, in particular a silica, having a BET specific surface area of less than 130 m²/g, and preferably in such a case of between 60 and 130 m²/g (see for example applications WO03/002648 and WO03/002649) can be used.

The physical state in which the reinforcing inorganic filler is present is immaterial, whether it be in the form of a powder, microbeads, granules, balls or any other appropriate densified form. Of course, “reinforcing inorganic filler” is also understood to mean mixtures of different reinforcing inorganic fillers, in particular of highly dispersible siliceous and/or aluminous fillers such as described above.

The person skilled in the art will be able to adapt the amount of reinforcing inorganic filler according to the nature of the inorganic filler used and the type of tire in question, for example motorcycle tire, passenger-vehicle tire or alternatively a tire for utility vehicles such as vans or heavy vehicles. However, preferably, this amount of reinforcing inorganic filler will be selected to be greater than 50 phr, in particular between 60 and 140 phr, more preferably still within a range from 70 to 130 phr in particular when the tread is intended for a passenger-car tire.

The reinforcing inorganic filler may also be used in a blend (mixture) with carbon black, the quantity of black possibly varying within wide limits but being preferably less than the quantity of reinforcing inorganic filler.

It is preferred to use, in addition to the reinforcing inorganic filler, carbon black in a preferred amount of between 2 and 20 phr, more preferably within a range from 5 to 15 phr. Within the ranges indicated, there is a benefit to be had from the colouring properties (black pigmentation agent) and anti-UV properties of the carbon blacks, without furthermore adversely affecting the typical performance provided by the reinforcing inorganic filler, namely low hysteresis (reduced rolling resistance) and high grip on wet, snow-covered or icy ground.

Suitable carbon blacks are all the carbon blacks capable of providing a black coloration to the rubber compositions, in particular the blacks of the type HAF, ISAF and SAF, which are known to the person skilled in the art and conventionally used in tires. Of the latter, mention may be made of the reinforcing carbon blacks of the series (ASTM grades) 100, 200 or 300 used in the treads of these tires (for example N115, N134, N234, N326, N330, N339, N347, N375), but also those of the non-reinforcing type (because they are less structured) of the higher series 400 to 700 (for example the blacks N660, N683, N772).

In the present specification, the BET specific surface area is determined in known manner by adsorption of gas using the method of Brunauer-Emmett-Teller described in “The Journal of the American Chemical Society” Vol. 60, page 309, February 1938, more precisely in accordance with French Standard NF ISO 9277 of December 1996 [multipoint volumetric method (5 points)—gas: nitrogen—degassing: 1 hour at 160° C.—range of relative pressure p/po: 0.05 to 0.17]. The CTAB specific surface area is the external surface area determined in accordance with French Standard NF T 45-007 of November 1987 (method B).

I-3. Coupling Agent

In known manner, in the presence of a reinforcing inorganic filler, it is necessary to use a coupling agent or bonding agent, the function of which is to provide a sufficient chemical and/or physical connection between the inorganic filler (surface of its particles) and the diene elastomer.

(Silica/diene elastomer) coupling agents, of variable effectiveness, have been described in a very large number of documents and are well-known to the person skilled in the art. Any coupling agent capable of ensuring, in the diene rubber compositions usable for the manufacture of tire treads, the effective bonding between a reinforcing inorganic filler such as silica and a diene elastomer, in particular organosilanes or polyorganosiloxanes which are at least bifunctional, may be used.

In particular polysulphurised silanes, which are referred to as “symmetrical” or “asymmetrical” depending on their specific structure, are used, such as those described for example in applications WO03/002648 and WO03/002649.

Particularly suitable, without the definition below being limitative, are what are called “symmetrical” polysulphurised silanes which satisfy the following general formula (I):
Z-A-Sₙ-A-Z, in which: (I)
n is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀ alkylenes, notably C₁-C₄ alkylenes, in particular propylene);
Z corresponds to one of the formulae below: 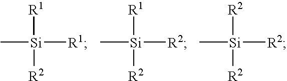
   in which:
the radicals R¹, which may or may not be substituted, and may be identical or different, represent a C₁-C₁₈ alkyl group, a C₅-C₁₈ cycloalkyl group or a C₆-C₁₈ aryl group, (preferably C₁-C₆ alkyl groups, cyclohexyl or phenyl, in particular C₁-C₄ alkyl groups, more particularly methyl and/or ethyl),
the radicals R², which may or may not be substituted, and may be identical or different, represent a C₁-C₁₈ alkoxyl group or a C₅-C₁₈ cycloalkoxyl group (preferably a group selected from among C₁-C₈ alkoxyls and C₅-C₈ cycloalkoxyls, more preferably still a group selected from among C₁-C₄ alkoxyls, in particular methoxyl and ethoxyl).

In the case of a mixture of polysulphurised alkoxysilanes in accordance with Formula (I) above, in particular conventional, commercially available, mixtures, the average value of the “n”s is a fractional number, preferably between 2 and 5, more preferably close to 4. However, the invention may also be implemented advantageously for example with disulphurised alkoxysilanes (n=2).

As examples of polysulphurised silanes, mention will be made more particularly of the polysulphides (in particular disulphides, trisulphides or tetrasulphides) of bis-((C₁-C₄)alkoxyl-(C₁-C₄)alkylsilyl-(C₁-C₄)alkyl), such as for example bis(3-trimethoxysilylpropyl) or bis(3-triethoxysilylpropyl) polysulphides. Of these compounds, in particular bis(3-triethoxysilylpropyl) tetrasulphide, abbreviated TESPT, of the formula [(C₂H₅O)₃Si(CH₂)₃S₂]₂, or bis(triethoxysilylpropyl) disulphide, abbreviated TESPD, of the formula [(C₂H₅O)₃Si(CH₂)₃S]₂, are used.

Mention will also be made, as other examples of coupling agents, of the polysulphides (in particular disulphides, trisulphides or tetrasulphides) of bis-(mono(C₁-C₄)alkoxyl-di(C₁-C₄)alkylsilylpropyl), more particularly of bis-monoethoxydimethylsilylpropyl, such as, for example, the tetrasulphide described in patent application WO 02/083782.

As examples of coupling agents other than the aforementioned polysulphurised alkoxysilanes, mention will be made in particular of the bifunctional POS (polyorganosiloxanes), or alternatively the hydroxysilane polysulphides (R²═OH in Formula I above) such as described in applications WO 02/30939 and WO 02/31041.

In the treads according to the invention, the content of coupling agent is preferably between 4 and 12 phr, more preferably between 3 and 8 phr.

The coupling agent could be grafted beforehand on to the diene elastomer or on to the reinforcing inorganic filler. However, it is preferred, in particular for reasons of better processing of the compositions in the uncured state, to use the coupling agent either grafted onto the reinforcing inorganic filler, or in the free (i.e. non-grafted) state.

I-4. Plasticising Agent: Glycerol Fatty Acid Triester

A second essential characteristic of the tread according to the invention is to comprise, as plasticising agent, a triester of glycerol and unsaturated C₁₂-C₂₂ fatty acid (that is to say comprising from 12 to 22 carbon atoms).

“Triester” and “fatty acid” are also understood to mean a mixture of triesters or a mixture of fatty acids, respectively. The fatty acid is preferably constituted majoritarily (to more than 50%, more preferably to more than 80% by weight) of an unsaturated C₁₈ fatty acid, that is to say one selected from among the group consisting of oleic acid, linoleic acid, linolenic acid and mixtures of these acids. More preferably, be it synthetic or natural in origin, the fatty acid used is constituted to more than 50% by weight, more preferably still to more than 80% by weight, of oleic acid.

In other words, very particularly a glycerol trioleate, derived from oleic acid and glycerol, is used. Among the preferred glycerol trioleates, mention will be made in particular, as examples of natural compounds, of the vegetable oils sunflower oil or rapeseed oil having a high content of oleic acid (more than 50%, more preferably more than 80% by weight).

Such triesters having a high content of oleic acid are well-known, and have been described for example in application WO 02/088238, as plasticising agents in treads for tires.

The glycerol triester is used in a preferred amount of between 5 and 80 phr, more preferably of between 10 and 50 phr, in particular within a range from 15 to 30 phr, in particular when the tread of the invention is intended for a passenger-type vehicle. In the light of the present description, the person skilled in the art will be able to adjust this amount of ester as a function of the specific conditions of embodiment of the invention, in particular the amount of inorganic filler used.

I-5. Various Additives

The rubber compositions of the treads according to the invention also comprise all or some of the conventional additives usually used in elastomer compositions intended for the manufacture of treads, such as, for example, other plasticisers (other than the glycerol triester) or extender oils, whether the latter be aromatic or non-aromatic in nature, pigments, protective agents such as anti-ozone waxes, chemical antiozonants, antioxidants, anti-fatigue agents, reinforcing resins, plasticising resins in particular of the hydrocarbon type such as those described in application WO 02/072688, methylene acceptors (for example novolac phenolic resin) or donors (for example HMT or H3M) such as described for example in application WO 02/10269, a cross-linking system based either on sulphur or on sulphur and/or peroxide and/or bismaleimide donors, vulcanisation accelerators and vulcanisation activators.

Preferably, these compositions comprise, as other preferred non-aromatic or only very slightly aromatic plasticising agent, at least one compound selected from among the group consisting of naphthenic oils, paraffinic oils, MES oils, TDAE oils, hydrocarbon plasticising resins preferably having a high Tg of preferably greater than 30° C., and mixtures of such compounds.

Of these hydrocarbon plasticising resins (it will be recalled that the designation “resin” is reserved by definition for a solid compound), mention will be made in particular of the resins of homopolymers or copolymers of alpha-pinene, beta-pinene, dipentene, C5 fraction, for example of C5 fraction/stirene copolymer, which are usable alone or in combination with plasticising oils such as MES or TDAE oils.

These compositions may also contain, in addition to the coupling agents, coupling activators, covering agents for the reinforcing inorganic filler or more generally processing aids capable, in known manner, owing to an improvement in the dispersion of the inorganic filler in the rubber matrix and to a reduction in the viscosity of the compositions, of improving their ability to be worked in the uncured state, these agents being for example hydrolysable silanes such as alkylalkoxysilanes, polyols, polyethers, amines, and hydroxylated or hydrolysable POS.

I-6. Manufacture of the Treads

The rubber compositions of the treads of the invention are manufactured in suitable mixers, using two successive preparation phases in accordance with a general procedure well-known to the person skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically less than 120° C., for example between 60° C. and 100° C., during which finishing phase the cross-linking or vulcanisation system is incorporated.

The process according to the invention for preparing a tire tread having improved grip on wet roads comprises the following steps:
incorporating in a diene elastomer comprising more than 30 phr of butyl rubber, in a mixer:
   a reinforcing inorganic filler;
   an (inorganic filler/elastomer) coupling agent providing the bond between the reinforcing inorganic filler and the diene elastomer;
   an unsaturated (C₁₂-C₂₂) fatty acid triester of glycerol,
by thermomechanically kneading the entire mixture, in one or more stages, until a maximum temperature of between 130° C. and 200° C. is reached;
cooling the entire mixture to a temperature of less than 100° C.;
then incorporating:
   a cross-linking system;
kneading the entire mixture until a maximum temperature of less than 120° C. is reached;
extruding or calendering the rubber composition thus obtained, in the form of a tire tread.

By way of example, the first (non-productive) phase is effected in a single thermomechanical step during which all the necessary constituents, any complementary coating agents or processing agents and various other additives, with the exception of the cross-linking system, are introduced into a suitable mixer, such as a conventional internal mixer. A second stage of thermomechanical working may possibly be added, in this internal mixer, for example after an intermediate cooling stage (preferably to a temperature of less than 100° C.), with the aim of making the compositions undergo complementary heat treatment, in particular in order to improve the dispersion, in the elastomeric matrix, of the reinforcing inorganic filler, its coupling agent and the plasticising agent.

After cooling the mixture thus obtained during the first, non-productive, phase, the cross-linking system is then incorporated at low temperature, generally in an external mixer such as an open mill; the entire mixture is then mixed (productive phase) for several minutes, for example between 5 and 15 minutes.

The cross-linking system proper is preferably based on sulphur and a primary vulcanisation accelerator, in particular an accelerator of the sulphenamide type. To this vulcanisation system there are added, incorporated during the first, non-productive, phase and/or during the productive phase, various known secondary accelerators or vulcanisation activators such as zinc oxide, stearic acid, guanidine derivatives (in particular diphenylguanidine), etc. The amount of sulphur is preferably between 0.5 and 3.0 phr, and the amount of the primary accelerator is preferably between 0.5 and 5.0 phr.

Any compound capable of acting as a vulcanisation accelerator for the diene elastomers in the presence of sulphur, in particular accelerators of the type of thiazoles and their derivatives, and accelerators of the type thiurams, zinc dithiocarbamates, can be used as accelerator (primary or secondary). These accelerators are more preferably selected from among the group consisting of 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (“DCBS”), N-tert. butyl-2-benzothiazyl sulphenamide (“TBBS”), N-tert.butyl-2-benzothiazyl sulphenimide (“TBSI”), zinc dibenzyldithiocarbamate (“ZBEC”) and mixtures of these compounds.

The final composition thus obtained is then calendered, for example in the form of a film or a sheet, in particular for characterisation in the laboratory, or alternatively extruded in the form of a rubber profiled element usable directly as a tire tread.

The vulcanisation (or curing) is carried out in known manner at a temperature generally between 130° C. and 200° C., for a sufficient time which may vary, for example, between 5 and 90 minutes, depending, in particular, on the curing temperature, the vulcanisation system adopted and the vulcanisation kinetics of the composition in question.

In the process according to the invention, in accordance with the preceding information given for the rubber compositions, preferably at least one, more preferably all, of the following characteristics are satisfied:
the butyl rubber is a halogenated butyl rubber;
the amount of butyl rubber is at least 40 phr;
the quantity of reinforcing inorganic filler is greater than 50 phr;
the quantity of coupling agent is of between 2 and 15 phr;
the maximum thermomechanical kneading temperature is between 145° C. and 185° C.;
the reinforcing inorganic filler is a siliceous or aluminous filler;
the at least bifunctional coupling agent is an organosilane or a polyorganosiloxane;
a butadiene/stirene copolymer (SBR) or a polyisoprene (IR) is associated with the butyl rubber;
the fatty acid of the glycerol triester is formed to more than 50% by weight of oleic acid.

More preferably, in this process, at least one, even more preferably all, of the following characteristics are satisfied:
the butyl rubber is a brominated butyl rubber;
the amount of butyl rubber lies within a range from 40 to 80 phr;
the quantity of inorganic filler is of between 60 and 140 phr, in particular within a range from 70 to 130 phr;
the quantity of coupling agent is of between 4 and 12 phr, in particular between 3 and 8 phr;
the reinforcing inorganic filler is silica;
the coupling agent is a bis-(C₁-C₄)alkoxysilylpropyl or bis-hydroxysilylpropyl polysulphide;
the SBR is an SBR prepared in solution and the IR is a natural rubber (NR);
the fatty acid of the glycerol triester is formed to more than 80% by weight of oleic acid.

The rubber compositions previously described, based on butyl rubber, a reinforcing inorganic filler, a coupling agent and the glycerol triester, may constitute the entire tread or only part of the tread according to the invention, in the case of a tread of composite type formed of several rubber compositions of different formulations.

The invention relates to the treads previously described, both in the uncured state (i.e. before curing) and in the cured state (i.e. after cross-linking or vulcanisation).

### II. EXAMPLES OF EMBODIMENT OF THE INVENTION

II-1. Preparation of the Rubber Compositions and Treads

For the following tests, the procedure is as follows: the reinforcing inorganic filler (silica), the coupling agent, the plasticising agent, the diene elastomer and the various other ingredients, with the exception of the vulcanisation system, are introduced in succession into an internal mixer filled to 70% of capacity, the initial tank temperature of which is approximately 60° C. Thermomechanical working (non-productive phase) is then performed in one stage, of a duration of about 3 to 4 minutes in total, until a maximum “dropping” temperature of 165° C. is obtained.

The mixture thus obtained is recovered, it is cooled and then sulphur and a sulphenamide-type accelerator are incorporated on an external mixer (homo-finisher) at 30° C., by mixing everything (productive phase) for an appropriate time (for example of between 5 and 12 minutes).

The compositions thus obtained are then calendered either in the form of plates (thickness of 2 to 3 mm) or of thin sheets of rubber in order to measure their physical or mechanical properties, or extruded in the form of treads for passenger-car tires.

II-2. Tests in Tires

In this test, two compositions, based on known SBR diene elastomers, reinforced by silica and comprising or not comprising a fraction of butyl rubber associated with a glycerol trioleate, are compared. Their formulations are given in the appended table.

The control composition C-1 comprises two known SBR and BR diene elastomers, and is conventionally used in what are called “green” tires of low energy consumption. The composition according to the invention C-2 comprises 50 phr of butyl rubber with which are associated 50 phr of an SBR of the same structure as the previous one (but devoid of aromatic oil), and also the glycerol fatty acid triester (sunflower oil having a high content of oleic acid).

Composition C-2 has the advantage of not comprising any aromatic oil, the latter being entirely replaced by the glycerol trioleate, to which is added a hydrocarbon plasticising resin (poly-alpha-pinene) such as described in the aforementioned application WO 02/072688.

Compositions C-1 and C-2 are used as treads of radial-carcass passenger-vehicle tires, referred to respectively as P-1 (control tires) and P-2 (tires according to the invention), of dimension 195/65 R15 (speed index H), which are conventionally manufactured and identical in all points except for the rubber compositions constituting their treads. Compositions C-1 and C-2 in the present case form all the respective treads.

All the tires are then mounted at the front of an automobile (Renault Laguna—front and rear pressure of 2.0 bar) fitted with an ABS braking system, to be subjected to a braking test on wet roads consisting of measuring the distance necessary to go from 50 km/h to 10 km/h upon sudden braking on wetted ground (asphalt concrete).

Under the conditions above, it was unexpectedly noted that the braking distance was reduced by 26%, or entirely significantly, for the vehicle fitted with the tires P-2 according to the invention, compared with the vehicle travelling on the control tires P-1.

TABLE

Composition No.

| | C-1 | C-2 |
|---|---|---|
| SBR (1) | 70 | — |
| BR (2) | 30 | — |
| SBR (3) | — | 50 |
| IIR (4) | — | 50 |
| carbon black (5) | 6 | 6 |
| silica (6) | 80 | 80 |
| coupling agent (7) | 6.4 | 6.4 |
| aromatic oil (8) | 33.0 | — |
| glycerol fatty acid triester (9) | — | 17.0 |
| plasticising resin (10) | — | 16.0 |
| DPG (11) | 1.5 | 1.5 |
| ZnO | 2.5 | 2.5 |
| stearic acid | 2 | 2 |
| anti-ozone wax | 1.5 | 1.5 |
| antioxidant (12) | 1.9 | 1.9 |
| sulphur | 1.1 | 1.1 |
| accelerator (13) | 2.0 | 2.0 |

(1) SBR (expressed as dry SBR) extended with 18% by weight (12.6 phr) of oil (or a total of 82.6 phr of extended SBR); 25% stirene, 58% 1,2-polybutadiene units and 23% trans-1,4-polybutadiene units (Tg = −24° C.);
(2) BR with 4.3% of 1-2; 2.7% of trans; 93% of cis 1-4 (Tg = −106° C.);
(3) SBR (dry SBR); 25% stirene, 58% 1,2-polybutadiene units and 23% trans-1,4-polybutadiene units (Tg = −24° C.);
(4) brominated butyl rubber (BIIR - ”EB2222“ from Exxon);
(5) carbon black N234;
(6) silica ”Zeosil 1165 MP“ from Rhodia, type ”HDS“ (BET and CTAB: approximately 160 m²/g);
(7) TESPT coupling agent (”Si69“ from Degussa);
(8) total aromatic oil (including extender oil for the SBR(1));
(9) glycerol trioleate (sunflower oil containing 85% by weight of oleic acid - ”Lubrirob Tod 1880“ from Novance);
(10) hydrocarbon resin of high Tg (poly-alpha-pinene ”R2495“ from Hercules);
(11) diphenylguanidine (Perkacit DPG from Flexsys);
(12) N-1,3-dimethylbutyl-N-phenylparaphenylenediamine (Santoflex 6-PPD from Flexsys);
(13) CBS (Santocure from Flexsys - 1.8 phr) + ZBEC (Vulkacit from Bayer - 0.2 phr).

(1) SBR (expressed as dry SBR) extended with 18% by weight (12.6 phr) of oil (or a total of 82.6 phr of extended SBR); 25% stirene, 58% 1,2-polybutadiene units and 23% trans-1,4-polybutadiene units (Tg=−24° C.);
(2) BR with 4.3% of 1-2; 2.7% of trans; 93% of cis 1-4 (Tg=−106° C.);
(3) SBR (dry SBR); 25% stirene, 58% 1,2-polybutadiene units and 23% trans-1,4-polybutadiene units (Tg=−24° C.);
(4) brominated butyl rubber (BIIR—“EB2222” from Exxon);
(5) carbon black N234;
(6) silica “Zeosil 1165 MP” from Rhodia, type “HDS” (BET and CTAB: approximately 160 m²/g);
(7) TESPT coupling agent (“Si69” from Degussa);
(8) total aromatic oil (including extender oil for the SBR(1));
(9) glycerol trioleate (sunflower oil containing 85% by weight of oleic acid—“Lubrirob Tod 1880” from Novance);
(10) hydrocarbon resin of high Tg (poly-alpha-pinene “R2495” from Hercules);
(11) diphenylguanidine (Perkacit DPG from Flexsys);
(12) N-1,3-dimethylbutyl-N-phenylparaphenylenediamine (Santoflex 6-PPD from Flexsys);
(13) CBS (Santocure from Flexsys—1.8 phr)+ZBEC (Vulkacit from Bayer—0.2 phr).

1. A tire tread comprising a rubber composition, said composition comprising a diene elastomer, a reinforcing inorganic filler, a coupling agent and a plasticising agent, wherein the diene elastomer comprises more than 30 phr of butyl rubber and the plasticising agent comprises an unsaturated (C₁₂-C₂₂) fatty acid triester of glycerol.

2. A tread according to claim 1, wherein the amount of butyl rubber is at least 40 phr.

3. A tread according to claim 2, wherein the amount of butyl rubber is within a range from 40 to 80 phr.

4. A tread according to claim 1, wherein the butyl rubber is a halogenated butyl rubber.

5. A tread according to claim 4, wherein the butyl rubber is a brominated butyl rubber.

6. A tread according to claim 1, wherein the fatty acid of the glycerol triester is for more than 50% by weight selected from among the group consisting of oleic acid, linoleic acid, linolenic acid and mixtures of these acids.

7. A tread according to claim 6, wherein the fatty acid comprises more than 50% by weight of oleic acid.

8. A tread according to claim 7, wherein the fatty acid comprises more than 80% by weight of oleic acid.

9. A tread according to claim 8, wherein the glycerol fatty acid triester is glycerol trioleate.

10. A tread according to claim 9, wherein the glycerol trioleate is present in the form of sunflower oil.

11. A tread according to claim 1, wherein the amount of glycerol triester is between 5 and 80 phr.

12. A tread according to claim 11, wherein the amount of glycerol trimester is between 10 and 50 phr.

13. A tread according to claim 12, wherein the amount of glycerol triester is within a range from 15 to 30 phr.

14. A tread according to claim 1, wherein the diene elastomer comprises, in addition to the butyl rubber, at least one elastomer selected from among the group consisting of polybutadienes, synthetic polyisoprenes, natural rubber, butadiene copolymers, isoprene copolymers and mixtures of these elastomers.

15. A process for preparing a tire tread having improved grip on wet roads, wherein said process comprises the steps of:
incorporating in a diene elastomer, in a mixer:
a reinforcing inorganic filler;
a coupling agent;
a plasticising agent,
by thermomechanically kneading the entire mixture, in one or more stages, until a maximum temperature of between 130° C. and 200° C. is reached;
cooling the entire mixture to a temperature of less than 100° C.;
then incorporating:
a cross-linking system;
kneading the entire mixture until a maximum temperature of less than 120° C. is reached;
extruding or calendering the rubber composition thus obtained, in the form of a tire tread;
wherein the diene elastomer comprises more than 30 phr of butyl rubber and the plasticising agent comprises an unsaturated (C₁₂-C₂₂) fatty acid triester of glycerol.

16. (canceled)

17. A tire comprising a tread according to claim 1.
